(19) United States
(12) Patent Application Publication
(10) Pub. No.: US 2026/0258694 A1
(43) Pub. Date: Sep. 3, 2026

(54) SECTIONAL DOOR WITH INTEGRATED ELECTRICAL COMPONENTS

(71) Applicant: CORNELLCOOKSON, LLC, Mason, OH (US)

(72) Inventors: Raymond Earl Howard, Las Vegas, NV (US); Alexander Alvarez Avila, Phoenix, AZ (US); Richard Ryan Severson Carroll, Loveland, OH (US); Andrey Vasiliyevich Melguy, Tempe, AZ (US); Robert Davis Sparks, Phoenix, AZ (US); Xin Cui, Tempe, AZ (US); Zhizhuo Wu, Tempe, AZ (US); Siva Prasanth Davuluri, Maosn, OH (US); Justin Michael Evans, Liberty Township, OH (US)

(73) Assignee: Clopay Corporation, Mason, OH (US)

(21) Appl. No.: 19/165,182

(22) PCT Filed: Mar. 21, 2023
(86) PCT No.: PCT/US2023/015835

§ 371 Date: Sep. 15, 2025

(51) Int. Cl. E06B 3/48; E05D 15/24; E05F 15/40; E06B 7/02

(52) U.S. Cl. CPC E06B 3/485; E05D 15/244; E06B 7/02; E05F 15/40; E05Y 2400/32; E05Y 2400/44; E05Y 2400/654; E05Y 2900/106; E06B 2007/023

(57) ABSTRACT

In example implementations, a panel of a sectional door is provided. The panel includes a panel housing, an integrated electrical component located within a body of the panel housing, and a constant power source electrically connected to the integrated electrical component. The integrated electrical component is located within an interior volume of the body of the panel housing or in the body of the panel housing.

### BACKGROUND

Doors can be used for a variety of applications. For example, doors can be used as in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening. One or more of the sections may have a wheel or endlock that can fit into a track. The track may guide movement of each section of the sectional door while opening and closing. The sectional door can be opened and closed manually with the help of a loaded torsion spring or mechanically via a motor or garage door opener.

### BRIEF DESCRIPTION OF THE DRAWINGS

FIG. 1 illustrates a block diagram of an example sectional door with an integrated electrical component of the present disclosure;

FIG. 2 illustrates a close up view of an example panel with an integrated electrical component within an interior volume of the panel of the present disclosure;

FIG. 3 illustrates cross-sectional view of an example panel with an integrated electrical component within an interior volume of the body of the present disclosure;

FIG. 4 illustrates a close up view of an example of panel with an integrated electrical component within a body of the panel of the present disclosure;

FIG. 5 illustrates an exploded view of an example panel with an integrated electrical component within the body of the present disclosure;

FIG. 6 illustrates examples of different types of integrated electrical components of the present disclosure; and

FIG. 7 illustrates a block diagram of example adjacent panels with integrated electrical components that are electrically wired through the body of the panel.

### DETAILED DESCRIPTION

Examples described herein provide examples of a sectional door with integrated electrical components. As discussed above, doors can be used for a variety of different applications. Some doors may be sectional doors, such as those used as garage doors.

Some sectional doors may be modified by consumers or manufacturers to include electrical components. However, these electrical components are typically installed after the sectional door is installed. The electrical components are typically added to the exterior side of the panel of the sectional doors. Electrically wiring may then be connected or soldered between a power source and the electrical component on the exterior side of the panels. In addition, the electrical wiring may be completely exterior to the sectional door. This may create a potential hazard caused by the wiring getting caught in a track of the sectional door and/or causing improper operation of the sectional door.

The present disclosure provides a sectional door with integrated electrical components. For example, the integrated electrical components may be a part of the sectional door when the sectional door is manufactured and be located inside of or within a panel of the sectional door. In contrast, current electrical components are typically aftermarket that are applied to an exterior of the sectional door.

In addition, the integrated electrical components may be powered via a constant power source. The wiring between the integrated electrical components and the constant power source may be routed within the panels of the sectional door. As a result, the electrical wiring may be located away from the track. Routing the electrical wiring within the panels may prevent entanglement or obstructions that could cause the sectional door to malfunction or operate improperly.

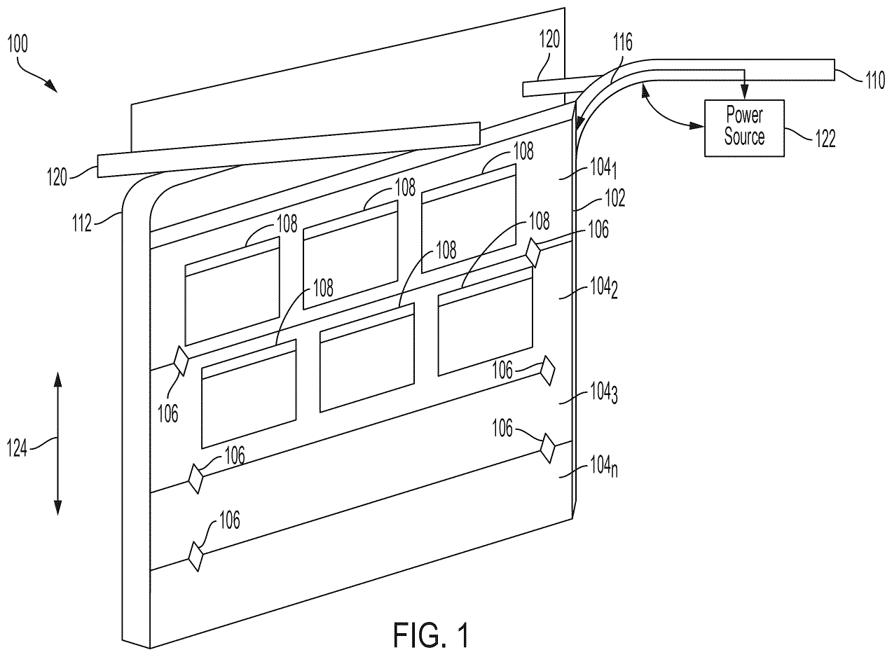

FIG. 1 illustrates a block diagram of a sectional door assembly 100 of the present disclosure. It should be noted that the sectional door assembly 100 in FIG. 1 has been simplified for ease of explanation. The sectional door assembly 100 may include additional features that are not shown. For example the sectional door 100 may include a header with a motor, rotating shaft, torsion springs, an operator, and a governor, a user interface to control operation of the sectional door, one or more sensors, and the like.

In one embodiment, the sectional door assembly 100 may include a sectional door 102 that comprises a plurality of panels or sections 104₁ to 104ₙ (hereinafter also referred to individually as a panel 104 or collectively as panels 104). The panels may be movably connected to one another via mechanical hinges 106. The first panel 104₁ may be the top most panel 104 and the last panel 104ₙ may be the bottom most panel 104.

In one embodiment, some of the panels 104 may include an integrated electronic component 108 that requires power. The electronic components 108 can be powered continuously or intermittently. For example, panels 104₁ and 104₂ may have integrated electronic components 108. In some examples, all of the panels 104 may include integrated electronic components 108.

An electrical wire or cord 116 may be run from a constant power source 122 to the integrated electronic components 108. The constant power source 122 may be constant in that the power source 122 is always available to deliver power continuously or intermittently to the electrical components 108. In other words, the constant power source 122 is not a battery or a capacitor and does not need to be recharged. As discussed in further details below, the electrical wire 116 may be routed within the body of the panel 104 to keep the electrical wire 116 away from a path of the sectional door 102 within tracks 110 and 112.

Although the electrical wire 116 is shown in FIG. 1 as delivering power from the power source 122, it should be noted that the electrical wire 116 may also be a wire for carrying data. For example, some of the electrical components 108 may include sensors or other types of devices that can generate data. The data may be transferred to and from the electrical components 108 via the electrical wire 116 or an additional data cable that is tied together with the electrical wire 116.

As noted above, electronic components are typically added to sectional doors with aftermarket components. Thus, the electronic components are added to the exterior of the sectional door and the wiring is also typically located to the exterior of the sectional door. The aftermarket electronic components may not be aesthetically pleasing and could interfere with the operation of the sectional door (e.g., opening or closing properly). In addition, the wiring located on the exterior of the sectional door may get tangled in the tracks and interfere with proper operation of the sectional door.

The integrated electronic components 108 of the present disclosure address these issue by being located inside of or within the panels 104. Further details of the integrated electronic components 108 are discussed in further details below.

The sectional door assembly 100 may include the tracks 110 and 112. The sectional door 102 may be guided by the tracks 110 and 112. The tracks 110 and 112 may be installed on opposite sides of the sectional door 102. A wheel or end lock (not shown) may be inserted into the tracks 110 and 112. In the case of a garage door, the garage door may have wheels that move within the tracks 110 and 112 as the garage door opens and closes in a direction as shown by an arrow 124.

The tracks 110 and 112 may be coupled to a wall of an opening where the sectional door 102 is installed. Support beams 120 that may be coupled to the wall may further help to stabilize the tracks 110 and 112.

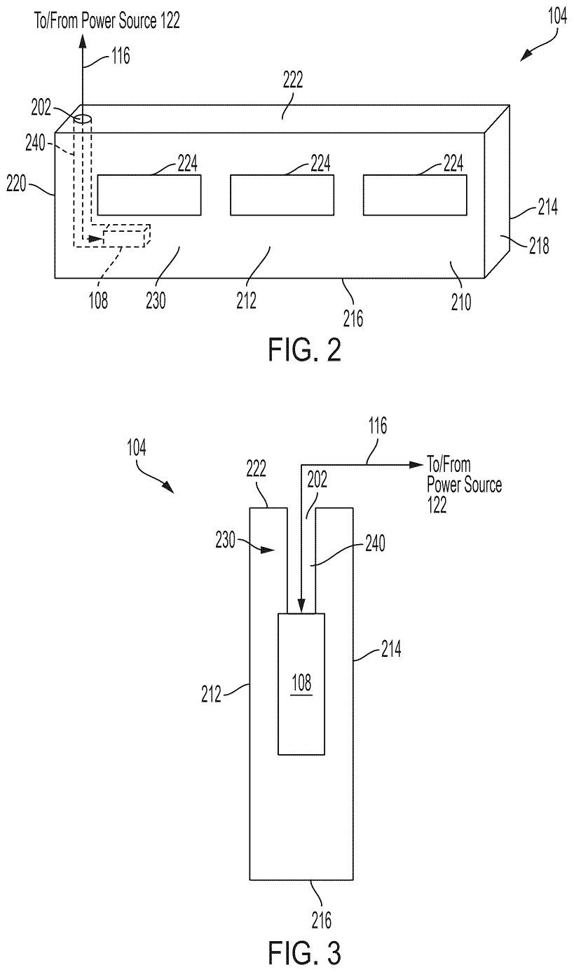

FIG. 2 illustrates a close up view of an example panel 104 with an integrated electrical component 108 within an interior volume of the panel 104. In one embodiment, the panel 104 may include a panel body 210. The panel body 210 may form an interior volume 230 that is defined by a front side 212, a back side 214, a bottom side 216, a left side 220, a right side 218, and top side 222.

The panel body 210 may also include openings 224 that may be filled with glass or windows in some designs. The openings 224 may be pre-cut or may be an opening formed by a combination of rails and stiles of the panel body 210. As discussed in further details below, the openings 224 may also receive modular integrated electrical components that can be placed within the panel body 210 in the openings 224.

In some embodiments, the interior volume 230 may be completely hollow. For example, the panel body 210 may be fabricated from composite, plastic, or metal panels that are assembled together to form the panel body 210. In some embodiments, the interior volume 230 may be filled by a material of the panel body 210. For example, in some examples, the panel body 210 may be fabricated as a solid steel panel.

Whether the panel body 210 is hollow or solid, the panel body 210 may include an opening 202 and an internal path 240. The internal path 240 is shown by dashed lines to indicate that the internal path 240 is hidden from view and located inside of the panel body 210. The electrical wire 116 may be routed from the power source 122, through the opening 202 and the internal path 240, and to the integrated electrical component 108.

The integrated electrical component 108 is shown in dashed lines to indicate that the integrated electrical component 108 is in the interior volume 230 of the panel body 210. In other words, the integrated electrical component 108 is hidden from view. The integrated electrical component 108 is affixed to a portion of the interior volume 230 when the panel 104 is manufactured. Internal wiring may be run from the integrated electrical component 108 to the opening 202 during manufacturing of the panel 104. As a result, when the sectional door 102 is installed, the electrical wire 116 may be connected to the internal wiring via the opening 202.

FIG. 3 illustrates a cross-sectional view of an example panel 104 with the integrated electrical component 108 within the interior volume 230 of the panel body 210. As noted above, the panel body 210 includes a front side 212, a backside 214, a bottom side 216, a top side 222, a left side 220, and a right side 218. The left side 220 and the right side 218 are not shown in FIG. 3.

The integrated electrical component 108 is located within the interior volume 230. In other words, the integrated electrical component 108 is located inside of panel body 210. The electrical wiring 116 may be routed from the power source 122 to the integrated electrical component 108 via the opening 202 and the internal path 240.

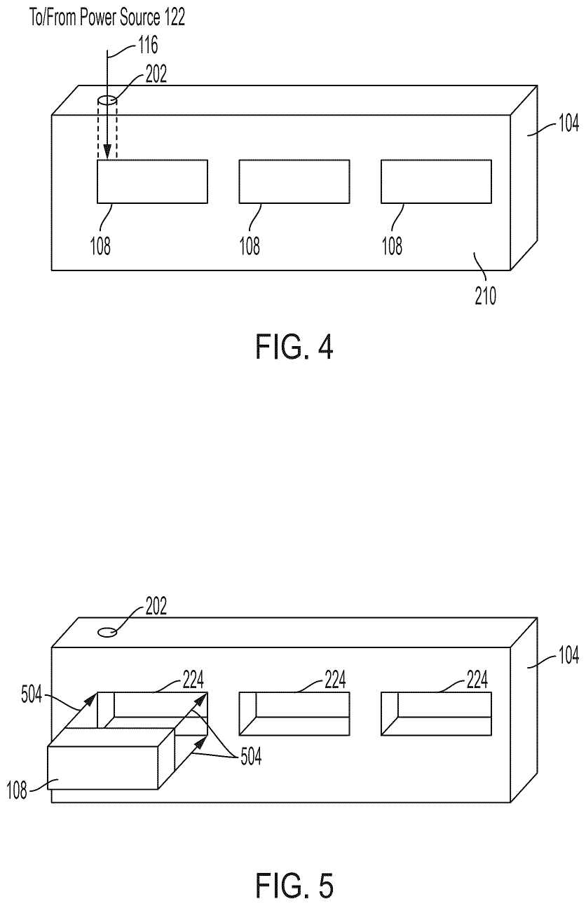

FIG. 4 illustrates a close up view of an example panel 104 with an integrated electrical component within the panel body 210. For example, the integrated electrical component may be located in the openings 224 of the panel body 210. The integrated electrical component 108 may be within the panel body 210 in that the integrated electrical component 108 is not on the exterior surface of the front side 212 or the back side 214. Moreover, the integrated electrical component 108 does not extend beyond the front side 212 or the back side 214. As a result, the electrical wiring 116 may be routed to the integrated electrical component 108 within the panel body 210 via the opening 202.

FIG. 5 illustrates an exploded view of the integrated electrical component 108 of the panel 104. For example, the integrated electrical component 108 may be inserted into the opening 224 as shown by arrows 504.

In one embodiment, the integrated electrical component 108 located within the panel body 210 may be a modular integrated electrical component 108. For example, the modular integrated electrical component may be enclosed within a glass panel or glass enclosure. The modular integrated electrical component may be assembled separately from the sectional door 102. However, the modular integrated electrical component may be a single component that is then located in the opening 224 and electrically connected to the electrical wire 116 that is routed within the panel body 210. As a result, the modular integrated electrical component may appear to be a part of the sectional door 102.

In one embodiment, the modular integrated electrical component may include lighting or other electronic components within a glass panel or glass enclosure. In another embodiment, the modular integrated electronic component may be enclosed within the same material as used to form the panel body 210. Thus, the modular integrated electrical component may appear to be a seamless part of the panel 104. For example, the front and back of the modular component may have panels with the same color, material, and texture as the color, material, and texture of the panel body 210.

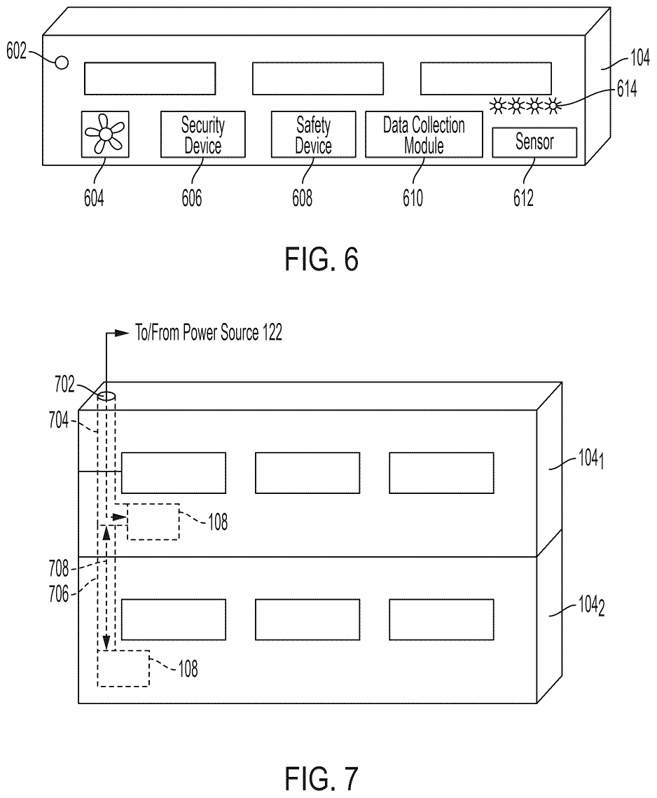

FIG. 6 illustrates different types of integrated electrical components of the present disclosure. Although FIG. 6 illustrates various types of integrated electrical components in the panel 104, it should be noted that a panel may include one or more of the different types of integrated electrical components illustrated in FIG. 6. In addition, the location of the different types of integrated electrical components within the panel 104 may vary.

In one embodiment, the integrated electrical component 108 may be a video camera 602. For example, the video camera 602 may be located inside of the panel 104 and pointed out of an opening to record video images. Thus, the video camera 602 may be part of a security system.

In one embodiment, the integrated electrical component 108 may be an internal fan 604. The internal fan 604 may be used to reduce an internal temperature of the panels 104 of the sectional door 102. The internal fan 604 may also help with venting and/or air flow.

In one embodiment, the integrated electrical component 108 may be a security device 608. For example, the security device 608 may be a speaker to emit an alarm, an internal horn, a flashing light to emit light through openings in the panel body 210, a motion sensor, and the like.

In one embodiment, the integrated electrical component 108 may be a data collection module 610. For example, the data collection module 610 may monitor operation of the sectional door 102 to collect data and/or information. The data collection module 610 may also include wireless radios to transmit and receive data wirelessly.

In one embodiment, the integrated electrical component 108 may include a sensor 612. For example, the sensor 612 may detect objects near the sectional door 102 to prevent the sectional door 102 from injuring a nearby person or damaging nearby equipment. The sensor 612 may be an environmental sensor that can detect moisture, smoke, fire, and the like. The sensor 612 may be tied with the security device 606 to generate an audible or visual alarm.

In one embodiment, the integrated electrical component 108 may include one or more lights 614. The lights 614 may be light emitting diodes (LEDs) that may be used as indicator lighting, used to illuminate an area, or generate a visual alarm. One or more openings may be cut on the panel body 210, such that the lights emitted from the lights 614 located inside of the panel body 210 may be visible.

Although a few examples of different types of integrated electronic components 108 are illustrated in FIG. 6 and discussed above, it should be noted that the examples should not be limiting. For example, the integrated electronic components 108 may include other types of electronic components that can be installed inside or within the panel body 210 and operate continuously or intermittently with power supplied by the constant power source 122. For example, addition electronic components 108 may include a modular display.

FIG. 7 illustrates a block diagram of example adjacent panels 104₁ and 104₂. The adjacent panels 104₁ and 104₂ may each have at least one integrated electronic component 108. However, rather than separately powering each integrated electronic component 108 via a dedicated electrical wire 116 to and from the power source 122, the present disclosure may only electrically connect the top most panel 104₁ to the power source 122. Then the adjacent panels 104₂-104n with integrated electronic components 108 may be electrically connected through inter-panel electrical wiring.

In other words, only the top most panel 104₁ may receive an electrical connection from the power source 122. Additional electrical wiring may be run from the electrical wire 116 in the top most panel 104₁ or from the integrated electrical component 108 to the integrated electrical component 108 in the adjacent panel 104₂. Then wiring may be routed from inside the panel 104₂ to inside the next adjacent panel 104₃, and so forth. This may minimize the amount of electrical wire 116 that is exposed outside of the panels 104 and minimize the opportunity for the electrical wire 116 to get tangled or interfere with operation of the sectional door 102.

Thus, the present disclosure provides sectional doors with integrated electrical components. The integrated electrical components may be installed as part of the fabrication of the sectional door. The integrated electrical components can receive continuous or intermittent power and be hidden from view inside of the panel body or appear to be a part of the sectional door being located within the panel body, as described above.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A panel of a sectional door, comprising:
a panel housing;
an integrated electrical component located within a body of the panel housing; and
a constant power source electrically connected to the integrated electrical component.

2. The panel of claim 1, wherein the panel is manufactured with the integrated electrical component.

3. The panel of claim 1, wherein the integrated electrical component is located within an interior volume of the body of the panel housing.

4. The panel of claim 3, wherein the integrated electrical component comprises at least one of: a sensor, a fan, an LED light, a security device, a safety device, or a data collection module.

5. The panel of claim 1, wherein the integrated electrical component comprises a modular component that is installed in the body of the panel housing.

6. The panel of claim 5, wherein the body includes an opening to receive the integrated electrical component.

7. The panel of claim 6, wherein the modular component is an electrical component within a modular glass enclosure.

8. The panel of claim 1, further comprising:
electrical wiring to connect the constant power source to the integrated electrical component, wherein the electrical wiring is routed within the body of the panel housing.

9. A sectional door, comprising:
a plurality of panels, wherein each panel comprises a panel housing;
an integrated electrical component located within a body of the panel housing of two or more adjacent panels of the plurality of panels; and
a constant power source electrically connected to the integrated electrical component.

10. The sectional door of claim 9, wherein the two or more adjacent panels comprise a top most panel and an adjacent panel below the top most panel.

11. The sectional door of claim 10, wherein the constant power source is electrically connected to the integrated electrical component of the top most panel via wiring that is routed through the body of panel housing of the top most panel.

12. The sectional door of claim 11, wherein the constant power source is electrically connected to the integrated electrical component of the adjacent panel via wiring that is routed through the body of the panel housing of the top most panel and through the body of the panel housing of the adjacent panel.

13. The sectional door of claim 9, wherein the panel is manufactured with the integrated electrical component.

14. The sectional door of claim 9, wherein the integrated electrical component is located within an interior volume of the body of the panel housing.

15. The sectional door of claim 14, wherein the integrated electrical component comprises at least one of: a sensor, a fan, an LED light, a security device, a safety device, or a data collection module.

16. The sectional door of claim 9, wherein the integrated electrical component comprises a modular component that is installed in the body of the panel housing.

17. The sectional door of claim 16, wherein the modular component is an electrical component within a modular glass enclosure.

18. A sectional door assembly, comprising:
a first track and a second track;
a sectional door comprising a plurality of panels, wherein the sectional door is movably coupled into the first track and the second track, wherein the first track and the second track guide a movement of the sectional door;
an integrated electrical component located within a body of a panel housing of at least one of the plurality of panels; and
a constant power source electrically connected to the integrated electrical component.

19. The sectional door assembly of claim 18, wherein the integrated electrical component is located within an interior volume of the body of the panel housing.

20. The sectional door assembly of claim 18, wherein the integrated electrical component comprises a modular component that is installed in the body of the panel housing.
